(19) United States
(12) Patent Application Publication
(10) Pub. No.: US 2006/0258342 A1
(43) Pub. Date: Nov. 16, 2006

(54) Methods and apparatus for providing wireless device-centric control of an external computing device

(76) Inventors: Kenny Fok, San Diego, CA (US); Eric Chi Chung Yip, San Diego (CA); Tia Manning Cassett, San Diego, CA (US)

Correspondence Address: QUALCOMM INCORPORATED, 5775 MOREHOUSE DR., SAN DIEGO, CA, 92121, US

(21) Appl. No.: 11/405,926

(22) Filed: Apr. 17, 2006

Related U.S. Application Data
(60) Provisional application No. 60/673,867, filed on Apr. 21, 2005.

(51) Int. Cl. H04Q 7/38; H04B 1/38; H04M 1/00

(52) U.S. Cl. 455/414.1; 455/557

(57) ABSTRACT

Apparatus and methods allowing a wireless device to utilize resources on a connectable external device may comprise installing a software component on the external device, the software component operable to enable communication between the wireless device and the desired resource on the external device. In other aspects, a wireless device resident application is operable to obtain an application install package from a remote server across a wireless network, and install, on-demand, an external device application on the external device.

### CLAIM OF PRIORITY UNDER 35 U.S.C. §119

The present Application for Patent claims priority to Provisional Application No. 60/673,867 entitled “Raptor Handset Centric Design (RHCD),” filed Apr. 21, 2005, assigned to the assignee hereof and hereby expressly incorporated by reference herein.

### BACKGROUND

The described embodiments generally relate to wireless communication devices. More particularly, the described embodiments relate to a wireless device interoperating with a connected external computing device.

Wireless devices are being manufactured with increased computing capabilities and are becoming tantamount to personal computers. These “smart” wireless devices, such as cellular telephones, have communication ports capable of being connected to external computing devices for such purposes as the uploading and downloading of data.

Despite the current capabilities of wireless devices, many aspects of wireless device testing are still performed under the control of a desk top or lap top computer.

Thus, it is desired to provide new and improved methods and apparatus that provide control of external resources through use of a wireless device.

### SUMMARY

The described embodiments comprise apparatus, methods, computer readable media and processors operable to provide a wireless device centric mechanism to utilize the device resources of an attached external device. Such embodiments may expand the functionality of existing wireless applications to take advantage of the resources of an attached external computing device.

In some aspects, a method of a wireless device utilizing a resource on a connected external device comprises executing on a wireless device an application operable to utilize a predetermined device resource. The wireless device comprises a first one of the predetermined device resource. Further, the method includes connecting an external device to the wireless device, wherein the external device comprises a second one of the predetermined device resource. Additionally, the method includes automatically switching the wireless device application between utilizing the first one of the predetermined resource and the second one of the predetermined resource. In related aspects, a machine-readable medium comprises instructions which, when executed by a machine, cause the machine to perform the above-stated operations. In other related aspects, at least one processor configured to perform the above-stated actions.

In other aspects, a wireless device comprises means for executing on a wireless device an application operable to utilize a predetermined device resource, wherein the wireless device comprise a first one of the predetermined device resource. Further, the device comprises means for connecting an external device to the wireless device, wherein the external device comprising a second one of the predetermined device resource. Additionally, the device comprises means for automatically switching the wireless device application between utilizing the first one of the predetermined resource and the second one of the predetermined resource.

In still other aspects, a wireless device comprises a processing engine and a memory accessible by the processing engine. Further, the device comprises a communication module operable to exchange communications between the processor and the memory, and between the wireless device and an external device having a first predetermined device resource. The device also comprises a second predetermined device resource in communication with the communication module. Further, the device comprises a first application resident in the memory and executable by the processing engine. The first application is operable to utilize either of the first predetermined device resource and the second predetermined device resource. Additionally, the device comprises a selection module resident in the memory and executable by the processing engine. The selection module is operable to automatically switch the first application between utilizing the second predetermined device resource and with the first predetermined device resource during execution of the first application.

In other aspects, a method of installing an application on an external device connected to a wireless device on a wireless network comprises receiving a command from the wireless device connected to the external device. The command comprises a request for an application management package executable on the wireless device, wherein the application management package is operable to install an external device application on the external device. The external device application is operable exchange data and execute in conjunction with a wireless device application executing on the wireless device. Additionally, the method includes transmitting the application management package to the wireless device. In related aspects, a machine-readable medium comprises instructions which, when executed by a machine, cause the machine to perform the above-stated operations. In other related aspects, at least one processor configured to perform the above-stated actions.

In still other aspects, an apparatus comprises means for receiving a command from a wireless device connected to an external device. The command comprises a request for an application management package executable on the wireless device, wherein the application management package is operable to install an external device application on the external device. The external device application is operable exchange data and execute in conjunction with a wireless device application executing on the wireless device. Additionally, the apparatus comprises means for transmitting the application management package to the wireless device.

In further aspects, an apparatus for transmitting an external device application to a wireless device comprises a processor and a memory in communication with the processor. The memory comprises an application management package executable on the wireless device, wherein the application management package is operable to install an external device application on the external device. The external device application is operable exchange data and execute in conjunction with a wireless device application executing on the wireless device. The apparatus further comprises a user manager control logic resident in the memory and executable by the processor. The user manager control logic configured to transmit the application management package to the wireless device across a wireless network.

Further, in other aspects, a method of using device resources on an external device connected to a wireless device comprises receiving on the wireless device a wireless device application. The method further includes executing the wireless device application whereby the application records device function-related data in a memory on the wireless device. Further, the method includes automatically determining that additional memory resources are required by the wireless device application. As such, the method includes connecting an external device comprising available memory to the wireless device. Further, the method includes automatically installing wireless device interface components on the external device, and recording the function-related data in the available memory of the external device. Additionally, in some aspects, the method may further comprise the wireless device automatically detecting, on the external device, a network connection to a remote server, and transmitting the stored function-related data to a remote server over the network connection detected on the external device.

### BRIEF DESCRIPTION OF THE DRAWINGS

The disclosed embodiments will hereinafter be described in conjunction with the appended drawings provided to illustrate and not to limit the disclosed embodiments, wherein like designations denote like elements, and in which:

FIG. 1 is a schematic diagram of one aspect of a system for providing wireless device centric control of an external device;

FIG. 2 is one aspect of a block diagram of the wireless device of FIG. 1;

FIG. 3 is one aspect of a block diagram of the external device manager of FIG. 1;

FIG. 4 is one aspect of a block diagram of the remote server of FIG. 1;

FIG. 5 is one aspect of a block diagram of the external device of FIG. 1;

FIG. 6 is a schematic diagram of one aspect of a cellular telephone network aspect of FIG. 1;

FIG. 7 is a flow chart associated with aspects of the operation of the wireless device of FIG. 1;

FIG. 8 is a flow chart associated with aspects of the operation of FIG. 7; and

FIG. 9 is a flow chart associated with one aspect of the operation of the remote server of FIG. 1.

### DETAILED DESCRIPTION

Apparatus and methods are herein described for expanding the functionality of a wireless device in interactions with external devices. Such apparatus and methods may provide wireless device-centric, also referred to as handset-centric, control of a connectable external computing device. In some aspects, for example, a wireless device may be utilized to control one or more device resources of an external computing device. For instance, a wireless device may utilize a resource such as a storage capability and/or a network connection on the external device. Furthermore, in other aspects, under control of the wireless device, a user may install external computing device applications, for example in an “on-demand” fashion, as well as install upgrades and/or patches for existing applications already installed on the external computing device.

In one non-limiting scenario, for example, the described aspects are useful for field-based testing, monitoring and/or analysis of wireless device functionality. In such a scenario, a technician may utilize a wireless device-based application to perform the desired functionality, and then may: (1) utilize an external device resource when available or appropriate; and/or (2) download a complementary application on an external device to work in conjunction with the wireless device application. In either case, the described embodiments allow for improving the efficiency, and automating the interaction between the wireless device and the external device. For instance, through the described aspects, the wireless device application may automatically establish communication with an external device, automatically scan the existing device drivers and applications, and automatically load new and/or updated drivers and/or applications which are relevant to the executing and/or planned application activities on the wireless device.

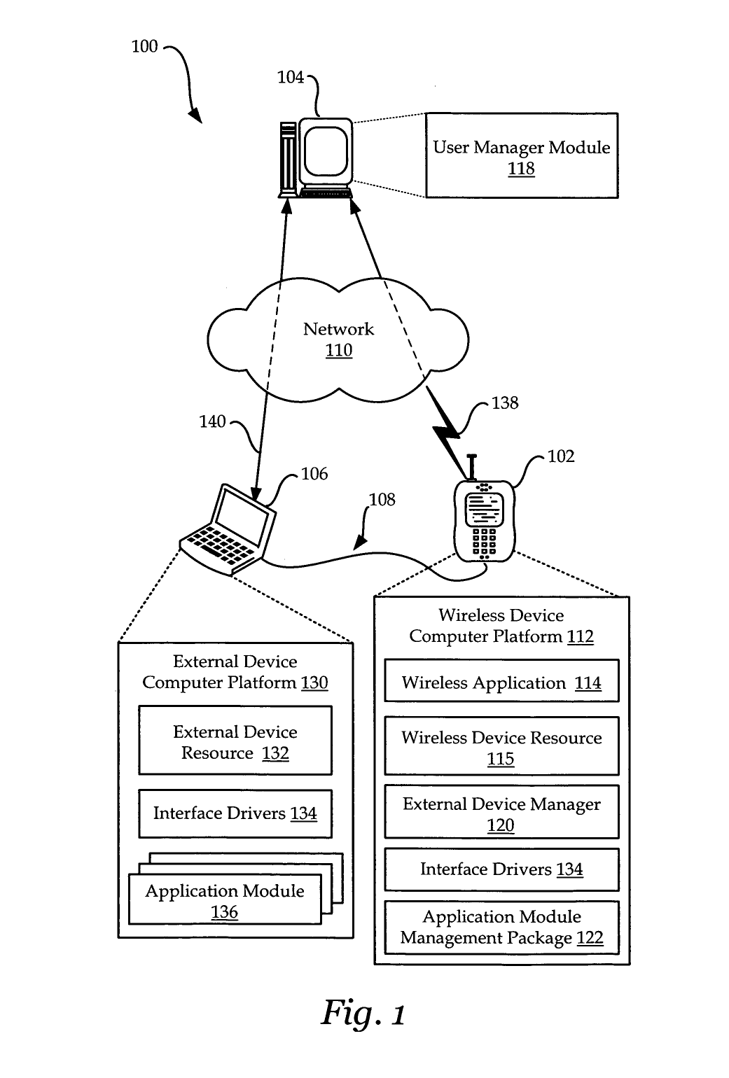

FIG. 1 illustrates one aspect of a system 100 operable to expand the functionality of a wireless device 102 by leveraging the resources of a connectable external computing device 106 and/or by installing an executable application module 136 on the external computing device 106 to manage, control and/or monitor a wireless application 114 executing on the wireless device 102.

In aspects of utilizing an external device resource, for example, wireless device 102 may comprise a computer platform 112 on which a wireless application 114 is installed. For example, wireless application 114 may comprise a diagnostic- and/or monitoring-type application operable to test and/or monitor predetermined functionality of the wireless device 102, and to record the corresponding data and/or corresponding device state information. This information collected by wireless application 114 may be used to analyze the predetermined functional parameters of the wireless device 102, either during normal operation and/or with regard to executing a given test. In any case, wireless application 114 may utilitze one or more wireless device resources 115, including any hardware and/or software component associated with the wireless device 102, during the execution of the wireless application 114. For example, a hardware and/or software component may include, but are not limited to, one or any combination of components such as a memory, a data storage, a processing capability, an output mechanism such as a display, audio speaker and/or haptic feedback mechanism, an input mechanism such as a key, keyboard, touch screen, voice recognition module and/or mouse, a communication interface, etc.

There may be cases where the wireless application 114 exhausts the resident wireless device resource 115, or where the function performed by the wireless device resource 115 is less than optimal and/or limited in some manner. In these instances, it may be advantageous for the wireless device 102 to find other resources to supplement the wireless device resource 115. For example, the wireless device 102 may further comprise an external device manager 120 operable to initiate communications with an external device 106 having an external device resource 132 that may be utilized by wireless application 114. For example, external device manager 120 may comprise one or more interface drivers 134, and external device manager 120 may be operable to install a selected one or more of these drivers on the external computing device 106. In particular, in these aspects, the selected ones of the one or more interface drivers 134 are operable to interface the wireless application 114 with a respective external device resource 132, for subsequent utilization by the wireless application 114. For example, external device resource 132 may comprise any hardware and/or software component of the external device 106. For instance, external device resource 132 may include, but is not limited to, one or any combination of a memory, a data storage, a processing capability, an output mechanism such as a display, audio speaker and/or haptic feedback mechanism, an input mechanism such as a key, keyboard, touch screen, voice recognition module and/or mouse, a communication interface, etc.

For example, in a case where external device resource 132 comprises a memory and/or data repository, wireless application 114 may transfer collected data, such as in the form of log files, from a resident wireless device memory to the external device memory or data repository. For example, such a data transfer may occur when the resident wireless device memory reaches a predetermined used capacity threshold, and/or the data may be transferred as it is collected in a streaming fashion. In another example, the external device resource 132 may comprise a communications link 140 to network 110. In a situation where the wireless device 102 does not have a communication link to the server 104, or where the communication link 140 of the external device 106 is relatively faster and/or more efficient than an equivalent wireless device-based link, the wireless device resident application 114 may access the external device resource 132 to enable communication with remote server 104. Thus, in these aspects, external device manager 120 is operable to enable wireless application 114 to utilize one or more external device resources 132.

In aspects of downloading applications onto the external device, for example, external device manager 120 may be operable to install an application module 136 on the external computing device 106. Application module 136 may be operable to interface with wireless application 114, such as to management and/or control functionality, and/or to provide post-processing capabilities in conjunction with the operation of wireless application 114.

For example, in a management and control case, application module 136 may comprise an application associated with wireless application 114 and having the functional ability to control, manage and change parameters associated with the execution of wireless application 114. For instance, in some aspects, wireless application 114 may gather diagnostic data from and/or run performance test on the wireless device 102, and application module 135 provides the ability to control what data is gathered and/or what tests are run, how the data is gathered and/or how the tests are performed, and how the data and/or performance test results is/are reported back to the application module 136 or to some other specified address. In another case, application module 136 may provide a tool for use in combination with wireless application 114, such as to improve the ease of use of wireless application 114. For example, if external device 106 has a larger display and a bigger keyboard than the corresponding display and keyboard on the wireless device 102, then application module 136 may provide the capability to utilize these user interface components on external device 106 to manage and control wireless application 114.

Further, for example, the wireless device 102 may have an air interface 138, such as a radio frequency (RF) link, to a network 110 connected to a remote server 104. In this example, the wireless application 114 may be operable to install application module 136 in an “on-demand” fashion, using an device driver/application module management package 122 downloaded via interface 138 from the remote server 104. In one aspect, device driver/application module management package 122 installs and/or uninstalls the application module 136 into a configurable location of external computing device 106. For instance, as mentioned above, the ability of the wireless device 102 to provide application module 136 to external device 106 may be desirable in situations such as field testing, where wireless access to a remote server may be the most feasible method of installing an application module 136 on the external computing device 106.

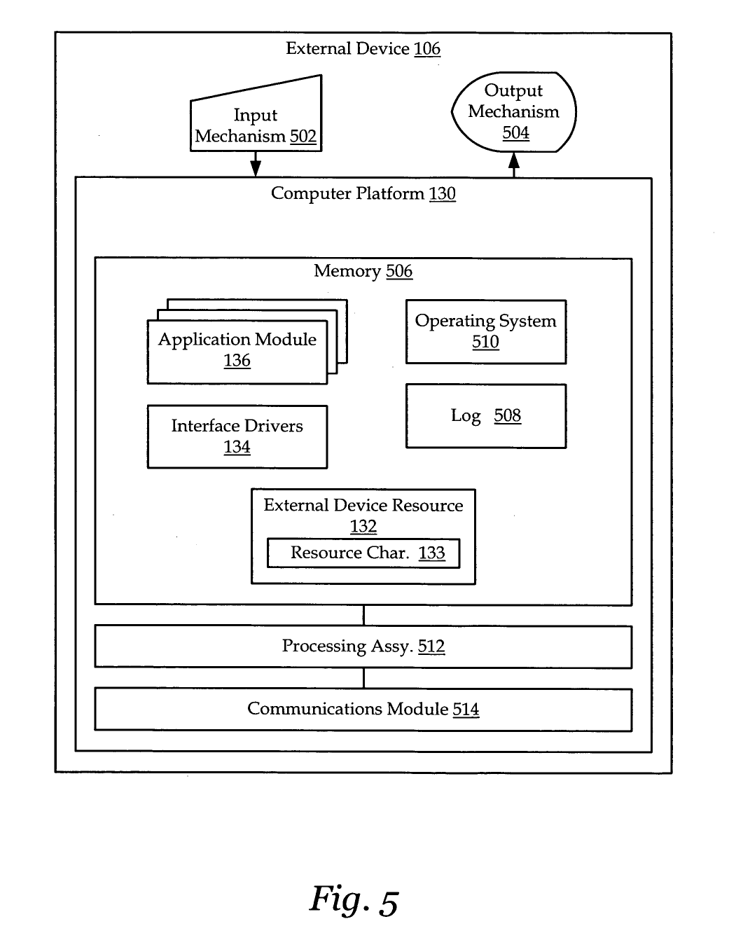

Alternatively, in some situations, an existing application module 136 on the external computing device 106 may be a non-current version. In another aspect of system 100, the external device manager module 134 may be operable to retrieve from the remote server 104 an upgrade and/or patch corresponding existing application module 136, and to further install the upgrade and/or patch in the memory 506 (FIG. 5) of the external computing device 106. It should be noted that the existing application module 136 does not need to be a module previously installed by wireless device 102 and/or external device manager 134.

The wireless device 102 may communicate with the external computing device through a communication interface 108. For example, communication interface 108 may include a wire or cable, or any interface mechanism to any communication port, including physical or wireless interfaces, available on the external device. For example, communication interface 108 may include, but not limited to, technologies such as a one or any combination of a wireless telecommunications interface, a serial port, a universal serial bus (USB) port, a FIREWIRE serial bus interface, an infrared interface and a short range radio frequency interface, such as a BLUETOOTH technology interface.

Although the embodiments disclosed herein may relate to wireless device resident application 114 executable to monitor, log and/or analyze data on hand-held wireless devices, the apparatus and methods of system 100 are non-limiting and may be directed to any wireless device resident application 114 operable to utilize one or more resources available on an external device 106.

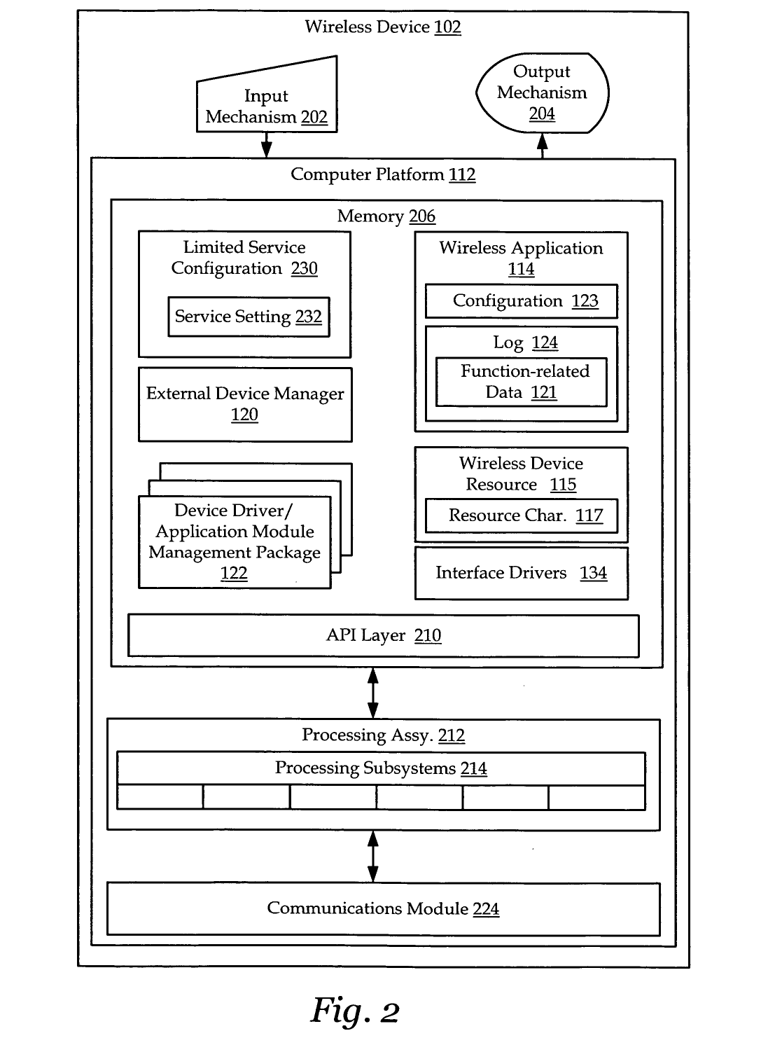

Referring to FIG. 2, wireless device 102 may include any type of computerized, wireless device 102, such as cellular telephone 102, personal digital assistant, two-way text pager, portable computer, and even a separate computer platform that has a wireless communications portal, and which also may have a wired connection to a network or the internet. The wireless device 102 can be a remote-slave, or other device that does not have an end-user thereof but simply communicates data across the wireless network 110, such as remote sensors, diagnostic tools, and data relays.

Wireless device 102 may also include an input mechanism 202 and an output mechanism 204 interconnected to a computer platform 206. Input mechanism 202 is operable to generate an input into wireless device 102, and may include a mechanism such as a key or keyboard, a mouse, a touch-screen display, and a voice recognition module. Output mechanism 204, may include a display, an audio speaker, and a haptic feedback mechanism, for example, for relaying information to the user of the wireless device 102.

Computer platform 112 may include a memory 206, which may further comprise volatile and nonvolatile memory, such as read-only and/or random-access memory (RAM and ROM), EPROM, EEPROM, flash cards, or any memory common to computer platforms. Further, memory 206 may include one or more flash memory cells, or may be any secondary or tertiary storage device, such as magnetic media, optical media, tape, or soft or hard disk.

Further, computer platform 112 may include a processing assembly 212, which may be an application-specific integrated circuit (ASIC), or other chipset, processor, logic circuit, or other data processing device operable to execute application programs resident in memory 206. Processing assembly 212 includes various processing subsystems 214 embodied in hardware, software, firmware, executable instructions, data, and combinations thereof, that enable the functionality of wireless device 102 and the operability of the wireless device 102 on network 110.

More specifically, processing subsystems 162 may permit the initiating and maintaining of communications, and the exchanging of data with other devices and applications executing on computer platform 206, including any subsystem component that receives data reads and data writes from an API layer 210. In one aspect, such as in a cellular telephone, processing subsystems 212 may include system monitors supporting such components, including: diagnostics, non-volatile memory, file system, transmit, receive, searcher, layer 1, layer 2, layer 3, main control, remote procedure, handset, power management, digital signal processor, video, camcorder, vocoder, messaging, call manager, position determination, position engine, user interface (UI), sleep, limited services, security, authentication, USIM/SIM, voice services, graphics, and multimedia such as MPEG, GPRS, etc.

API layer 210 may comprise software components that interface memory resident application programs with processing assembly 212 and the subsystems comprised therein. In one aspect, API layer 210 is a runtime environment executing on the respective wireless device 102. One such runtime environment is Binary Runtime Environment for Windows (BREW) software developed by Qualcomm, Inc., of San Diego, Calif. Other runtime environments may be utilized that, for example, operate to control the execution of applications on wireless computing devices.

Wireless applications may be loaded into memory 206 by various mechanisms including, but not limited to, downloading from any computer device physically attached to, or in communication with wireless device 102, e.g., remote server 104.

One such wireless application may comprise a wireless application 114 operable to monitor and/or test a predetermined functional capability of the wireless device 102, and record the corresponding function-related data 121. For example, wireless application 114 may comprise a configuration 123 having parameters, for example, that dictate which device data to monitor and/or record, what tests to perform, and how to report the collected data. For example, function-related data 121 may include, but is not limited to, data such as records from processing subsystems 214, device component state information, over-the-air (OTA) messages, and any other data that may reflect wireless device functionality and/or a state of the wireless device before, during, and/o after the monitored and/or tested activity. In some aspects, the wireless application 114 may store function-related data 121 in a log 124, while in other aspects, the function-related data 121 may be streamed to the external device 106 (FIG. 1) based on the principles discussed herein.

Another wireless application may include external device manager 120 that may comprise one or any combination of hardware, software, firmware, executable instruction, and data, configured to provide wireless application 114 with access to the resources of a connected external computing device 106.

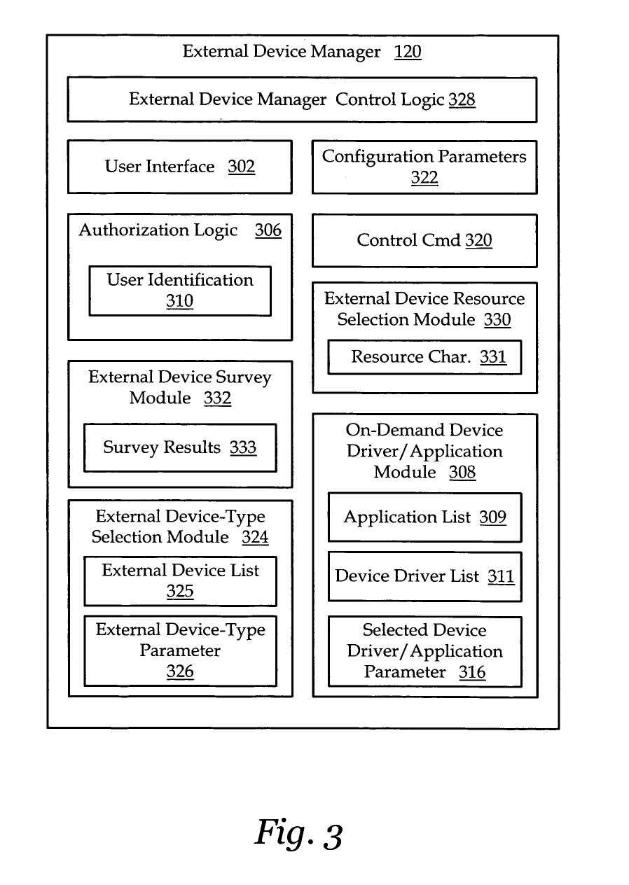

Referring to FIGS. 2 and 3, the external device manager 120 is operable to provide a wireless device-centric mechanism for accessing external device resources 132 (see FIG. 1) and for installing an application module 136 executable on the external device 106. It should be noted that external device manager 120 may be utilized by any application resident on wireless device 102. In one aspect, the external device manager 120 and wireless application 114 may be separate modules. In other embodiments, the external device manager 120 may be integrated within the software of the wireless application 114.

The external device manager 120 may comprise control logic 328 operable in conjunction with user interface 302, to manage all functions of the external device manager 120. For example, upon initial connection of an external device 106 to a wireless device 102, external device manager 120 may initiate the loading of one or more interface drivers 134 onto the external device 106 in order to allow wireless device 102 to access the resources of the external device 106. Interface driver 134 enables the wireless application 114 to communicate with and issue commands to a respective external device resource 132. For example, interface driver 134 may operate to direct the data received by the external device 106 to the appropriate device resource, e.g., memory device, display unit, and/or network adapter. Further, external device manager 120 may control the execution of device driver/application module management package 122 with respect to external device 106, for example, for installing and uninstalling one or more application modules 136.

Further, for example, in some aspects the external device 106 may comprise one of any of a plurality of different types of personal computers each comprising, for example, different operating systems, e.g., Win32, Linux, etc. As such, external device manager 120 may include a mechanism, i.e., an external device-type selection module 324 having an external device list 325 comprising supported external device types, operable to allow a user to select a device type specific to the external device 106 connected to the wireless device 102. The selected device type may be stored as external device-type parameter 326 and may be transmitted to the remote server 104. In particular, external device-type parameter 326 may include, but is not limited to, one or any combination of a device manufacturer, device model, device operating system, operating system version, device hardware component, device hardware component version, device software component, device software component version, and any other information that may be useful for enabling an interface between the wireless device 102 and the external device 106.

Additionally, in some aspects, external device manager 120 may be operable to transmit a request to the remote server 104 in order to gather relevant applications and/or device drivers for the specific external device. For example, the request may include the external device-type parameter 326, which the remote server 104 may correlate with corresponding applications and/or device drivers. As such, in response to the request, external device manager 120 may receive and store an on-demand application/device driver module 308 specific to the attached external device 106. For example, the application/device driver module 308 may include an available application list 309 and an available device driver list 311, thereby allowing a user to select a specific application and/or device driver to install on the external device 106.

Based upon a selection from the available application list 309 and/or the available device driver list 311, the external device manager 120 may generate and transmit another request to remote server 104. For example, the request may include the selected application/device driver parameter 316, which may include, but is not limited to, an application/device driver identifier. In response, the external device manager 120 may receive from the remote server 104 a corresponding device driver/application module management package 122 that may be downloaded to the wireless device 102 from remote server 104. The device driver/application module management package 122 may include the requested application and/or device driver executable by the external device 106 to interface with the wireless device 102 and wireless application 114.

Furthermore, at any point during communications with the remote server 104 and/or the external device 106, authorization logic 306 disposed in the external device manager 120 may be operable to validate the identity of the wireless device 102. Authorization schemes include, but are not limited to, exchanging user information 310, e.g., username/password information.

External device manager 120 may further comprise configuration settings 322 that may include the network address of a remote server, e.g., remote server 104, from which to download, for example, the on-demand application/device driver module 308, the interface drivers 134, and the device driver/application module management package 122.

External device manager control logic 328 may also be operable to generate and transmit a control command 320 to the remote server 104 and/or the external device 106. For example, control command 320 may comprise the above-described request messages, and/or an acknowledgment message transmitted to the remote server 104 upon successful receipt of data, e.g., device drivers 134, external device-type module 324, on-demand application/device driver module 308, and device driver/application module management package 122. Further, for example, control command 320 may be any message initiating an operation executable on the external computing device 106. For example, such operations include, but not limited to, one or any combination of storing received data at a specific location in memory 506 (FIG. 5), transmitting/receiving data from a configurable network 110 location, and uninstalling a previously installed application module.

Furthermore, the external device manager 120 may comprise external device resource selection module 330 having selection logic 331 operable to survey the available external device resources 132 on the external device 106, and to provide the user of the wireless device 102 with the ability to select one or more of the external device resources 132 to utilize. In some aspects, each resident wireless device resource 115 includes a wireless device resource characteristic 117 (FIG. 2) that identifies one or more parameters relating to the current and/or existing functional capability of the respective component. Similarly, each external device resource 132 (FIG. 5) may have an external device resource characteristic 133 (FIG. 5) that identifies one or more parameters relating to the current and/or existing functional capability of the respective component. As such, in some aspects, the external device resource selection module 330 may be operable to automatically monitor the state of the respective wireless device resource characteristic 117 and a corresponding one of the external device resource characteristic 133, and switch their utilization by wireless application 114 depending on their respective states. In this regard, selection logic 331 may includes predetermined rules, algorithms, routines, fuzzy logic, heuristic relationships, etc. for determining which resource is optimal at any given time. Further, it should be noted that selection logic 331 may further provide choices to a wireless device user with regard to which respective device resource to use.

For example, in one scenario, such as when the wireless application 114 needs to transmit collected data 121 to another device, such as the remote server 104, the external device manager 120 may provide a listing of one or more external device communication interface capabilities, which may be presented with available wireless device communication interface capabilities. This listing allows a user of wireless device 102 to select one or more desired communications interfaces based on the particular requirements of the situation. For example, the external device 106 may have a network connection to network 110 that is faster than the air interface 138 available on the wireless device 102, and in some scenarios a faster connection may be desired. In other scenarios, however, the external device may have a relatively fast or relatively high bandwidth data connection that is more expensive than an alternate data connection having a relatively slower or relatively lower bandwidth. A user of wireless device 102 may then be able to determine if the extra cost is worth it. For instance, if the data to be transferred is non-urgent, then the relatively slower data connection may be sufficient. In any case, external device resource selection module 330 may be configurable to provide the identification of available resources, and to allow for the selection of one or more desired resources for use in combination with wireless application 114. Additionally, external device resource selection module 330 may further be operable to analyze and automatically select an optimal configuration of resident resources and/or external device resources based on predetermined rules, settings, fuzzy logic, heuristic relationships, neural networks, etc.

Additionally, external device manager 120 may comprise an external device survey module 332 operable to gather information relating to device drivers and applications resident on a connected external device 106. For example, external device survey module 332 is operable to collect survey results 333, which may include lists of device drivers and/or applications, including names, identifiers, version numbers, and any other information useful in identifying if the respective device driver and/or application is current. Further, the external device survey module 332, and/or external device manager 120, may be operable to compare the survey results 333 with a list of known, current version of the respective device driver and/or application, such as may be retrieved from remote server 104 by on-demand device driver/application management module 308. In any case, the external device survey module 332, and/or external device manager 120, may be operable to generate a list that identifies which ones, if any, of the listed device drivers and/or applications in survey results 333 are not current, thereby allowing for subsequent updating, as is discussed below.

Communication between wireless device 102 and one or both of the remote server 104 and the external device 106 may be established by a communications module 224. Communications module 224 may be embodied in any one of hardware, software, executable instructions, data, and combinations thereof, operable to enable communications among the various components of the wireless device 102, the external device 106, wireless network 110 and other devices connected to wireless network 110.

Communications module 224 may comprise any component operable to transmit and/or receive data and communications between the resident components of the wireless device 102, and between the wireless device 102 and any other external device. For example, communications module 224 includes transmit and receive chain components, including any port and/or interface that may include any point of entry into, and/or any point of exit from wireless device 102.

In some aspects, wireless device 102 and remote devices, e.g., remote server 104, may communicate over a limited-access communications channel across wireless network 110. The communication channel may be set up based upon a limited service configuration 230 and may be used for transmitting test data, stored either on the wireless device 102 and/or the computing device 106, to the remote server 104 or for downloading at least portions of wireless application 114 and external device manager 120, to the wireless device 102. The limited-access communications channel is generally not available to the end user and may be configured based on a limited service setting 232 identifying allowable types of communications, and the associated communication channels that may be utilized. Limited service configuration 230 may be downloaded over wireless network 110, may be locally transferred to wireless device 102, such as through a serial connection, or may be preloaded on the wireless device 102.

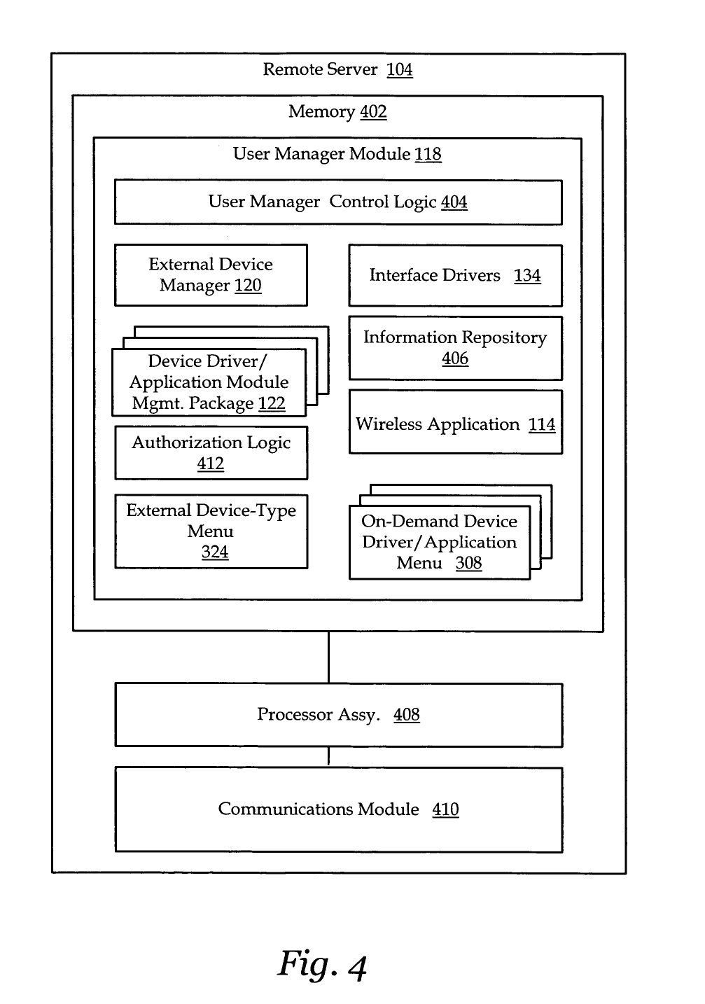

Referring to FIG. 4, remote server 104 (or plurality of servers) may comprise at least one of any type of processor assembly 408, server, personal computer, mini computer, mainframe computer, terminal, or any computing device either special purpose or general computing device operable to send software agents or applications, e.g., wireless application 114; external device manager 120; on-demand device driver/application module 308; interface driver 134; and one or more device driver/application module management package 122, to wireless device 102 across wireless network 110. Further, there can be separate servers or computer devices associated with remote server 104 that work in concert to download data to, and store data received from, the wireless device 102 and external device 106.

In addition, remote server 104 may comprise communications module 410 operable to connect remote server 104 to network 110. Furthermore, communications module 410 may allow remote server 104 to be directly accessed by a network connected external device 106.

Remote server 104 may further comprise a memory 402 and a memory resident user manager module 118 that may include software, hardware, data, and generally any executable instruction operable to manage the downloading of data to and from wireless device 102 and/or wireless device 102, e.g., user manager control logic 404.

User manager module 118 may further include information repository 406, comprising any type of memory and/or storage device and operable to store data received from wireless device 102 and/or wireless device 102.

As previously disclosed, remote server 104 may comprise the wireless application 114, interface driver 134, an on-demand device driver/application module 308, an external device manager 120, and an device driver/application module management package 122, which may be available for downloading to the wireless device 102

Furthermore, authorization logic 412 disposed in the user manager module 118 may be operable to validate the identity of a wireless device 102 attempting to transmit or receive data to/from the remote server 104. Authorization schemes include, but are not limited to, exchanging user information 310, e.g., username/password information, transmitted by the wireless device 102 (see FIG. 3).

The actual location of the disclosed components of the user manager module 118 is non-limiting and may be physically located on a server or other device connected to network 110.

Referring to FIG. 5, while in some aspects the external device 106 may be a portable laptop computer, the physical attributes of external device 106 are non-limiting. For example, external device 106 may comprise, but is not limited to, at least one of any type of laptop computer, personal computer, mini computer, mainframe computer, terminal, or any computing device either special purpose or general computing device having device resources, e.g., memory, data storage, network connections, output mechanisms, etc., that may be made available to a wireless device application 114.

In some aspects, external device 106 may comprise a processing assembly 512, executing a memory resident operating system 500, e.g., Linux, Win32, etc. Furthermore, the external device 106 may comprise a communications module 514 operable to transmit and receive messages and data to/from the wireless device 102. External device 106 may communicate with the wireless device 102 via any available interface, e.g., serial port, USB, FIREWIRE, BLUETOOTH, infrared, etc.

External device 106 may further comprise an input mechanism 502 and an output mechanism 504, e.g., a display screen such as an LCD screen, interconnected to computer platform 130. The input mechanism 502 and the output mechanism 504 may permit an authorized user to interface directly with an application module 136 downloaded from the wireless device 102, and to interface with wireless device application 114.

The external device computer platform 130 may further comprise a memory 506 configured to store one or more application module 136, one or more interface drivers 134, and data received from the connected wireless device 102. In some aspects, for example, log 508 may store batch files and/or streaming OTA messages, function data, wireless device component state information, etc., collected by the wireless device 102. An application module 136, such as a diagnostic monitor and logger, may be operable for viewing the OTA messages on an output mechanism 504 and/or storing the collected information in log 508 for subsequent transmittal to the remote server 104 or any other predetermined destination.

Referring back to FIG. 1, network 110 may include any communications network operable, at least in part, for enabling wireless communications between wireless device 102 and any device connected to network 110. Further, network 110 may include all network components, and all connected devices that form the network. For example, network 110 may include at least one, or any combination, of: a cellular telephone network; a multicast network such as a Forward Link Only (FLO) network, such as the MEDIAFLO System available from Qualcomm, Inc. of San Diego, Calif.; a digital video broadcasting (DVB) network, such as DVB-S for satellite, DVB-C for cable, DVB-T for terrestrial television, DVB-H for terrestrial television for handhelds; a terrestrial telephone network; a satellite telephone network; an infrared network such as an Infrared Data Association (IrDA)-based network; a short-range wireless network; a BLUETOOTH technology network; a ZIGBEE protocol network; an ultra wide band (UWB) protocol network; a home radio frequency (HomeRF) network; a shared wireless access protocol (SWAP) network; a wideband network, such as a wireless Ethernet compatibility alliance (WECA) network, a wireless fidelity alliance (“Wi-Fi Alliance”) network, and a 802.11 network; a public switched telephone network; a public heterogeneous communications network, such as the Internet; a private communications network; and a land mobile radio network.

Suitable examples of telephone networks include at least one, or any combination, of analog and digital networks/technologies, such as: code division multiple access (CDMA), wideband code division multiple access (WCDMA), universal mobile telecommunications system (UMTS), advanced mobile phone service (AMPS), time division multiple access (TDMA), frequency division multiple access (FDMA), orthogonal frequency division multiple access (OFDMA), global system for mobile communications (GSM), single carrier (1X) radio transmission technology (RTT), evolution data only (EV-DO) technology, general packet radio service (GPRS), enhanced data GSM environment (EDGE), high speed downlink data packet access (HSPDA), analog and digital satellite systems, and any other technologies/protocols that may be used in at least one of a wireless communications network and a data communications network.

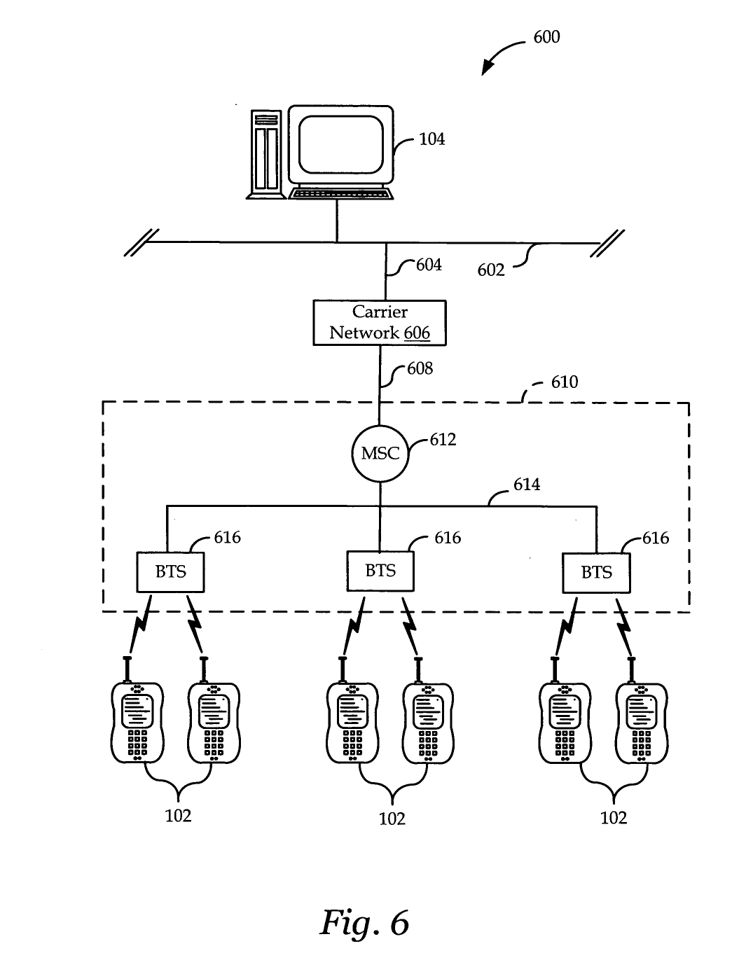

Referring to FIG. 6, an aspect of a system 600 similar to system 100 comprises at least one wireless device 102 and a cellular telephone wireless network 610 connected to a wired network 602 via a carrier network 606. Cellular telephone system of 610 is merely exemplary and may include any system whereby remote modules, such as wireless devices 102, communicate packets including voice and data over-the-air between and among each other and/or between and among components of network 110, including, without limitation, wireless network carriers and/or servers.

According to network 110, remote server 104 may communicate over a wired network 602 (e.g. a local area network, LAN) for storing data received from wireless device 102. The remote server 104 may be present on the network 602 along with any other network components needed to provide cellular telecommunication services.

Remote server 104 may communicate with carrier network 606 through data links 604, such as the Internet, a secure LAN, WAN, or other network. Carrier network 606 controls messages (generally being data packets) sent to a mobile switching center (MSC) 612. Further, carrier network 606 communicates with MSC 612 by a network 608, such as the Internet, and/or POTS (“plain old telephone service”). Typically, in network 610, a network or Internet portion transfers data, and the POTS portion transfers voice information. MSC 612 may be connected to multiple base stations (BTS) 616 by another network 614, such as a data network and/or Internet portion for data transfer and a POTS portion for voice information. BTS 616 ultimately broadcasts messages wirelessly to the wireless devices 102, by short messaging service (SMS), or other over-the-air (OTA) methods.

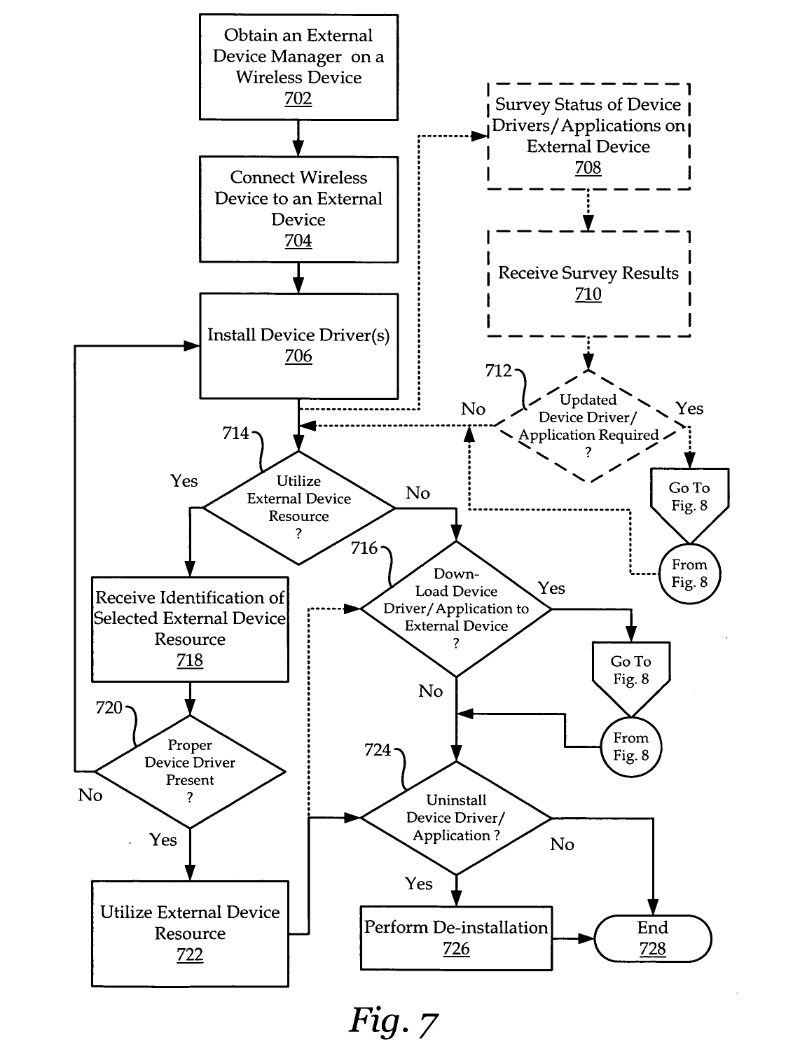

In operation, referring to FIG. 7, in some aspects, a method is illustrated to allow a wireless device to utilize an external device resource on a connected external device, and/or to allow the wireless device to perform an on-demand installation of an application on the external device. At step 702, an external device manager 120 capable of providing the requisite logic and mechanisms to implement the external resource utilization and application download capabilities may be loaded into memory 206 of the wireless device 102. For example, any one of a plurality of mechanisms may be utilized to load the external device manager 120 onto wireless device 102, including, but not limited to, wireless transmission over network 110 from a network device, e.g., remote server 104, loading from another device directly connected to the wireless device, and loading upon the manufacture of the wireless device.

Further, for example, in some aspects, the wireless device 102 may transmit a command 320 to the remote server 104 requesting external device manager 120. The communication between the wireless device 102 and the remote server 104. In some aspects, the command 320 may be transmitted across a limited access service channel, for example, based on service settings 232 defined within limited service configuration 230. In any case, the connection protocol may be hyper-text transfer protocol (HTTP), file transfer protocol (FTP) or any other protocol available to enable the transmission of data over the network 110. Furthermore, in some aspects, remote server authorization logic 412 and authorization logic 306 present in the external device manager 120 of the wireless device 102 may operate to authenticate the identity of the wireless device 102 based upon user identification information 310. Such user identification information 310 may include configurable username/password information.

The method may further include connecting an external device to the wireless device (Step 704). For example, external device 106 may be connected to wireless device 102 via a communication interface 108. Communication interface 108 may be any mechanism that allows the exchange of data and/or communications between the two devices, such as a direct electrical connection, an air link and/or radio wave connection, etc.

Upon connecting the two devices, the method includes the wireless device installing device drivers onto the external device (Step 706). For example, external device manager 120 may execute device driver/device driver/application module management package 122, which is operable to download one or more interface drivers 134 onto the external device 106. In some aspects, the one or more interface drivers 134 may include an initial download package of a set of predetermined device drivers. For instance, the initial download package may include device drivers operable to enable wireless device 102, including wireless application 114 and/or external device manager 120, to utilize one or more predetermined external device resources 132, such as typical resources that may be commonly utilized, including a memory and/or a data storage, a processor, a communications interface, a display, a keyboard, a mouse, etc. Further, for example, the initial download package may include the above-stated device drivers in sets corresponding to a plurality of operating systems. As such, the operating system 510 of the external device 106 is operable to recognize and download at least one of the plurality of sets of initial device drivers, thereby enabling communications between the external device 106 and the wireless device 102.

Optionally, once communications between the two devices have been established, the method may further include the wireless device initiating a survey of the status of device drivers and/or applications on the external device to determine if these components are up-to-date (Step 708). For example, external device manager 120 may execute an external device survey module 332 operable to identify device drivers and applications on external device, including name, version number and any other information relating to status of the respective item.

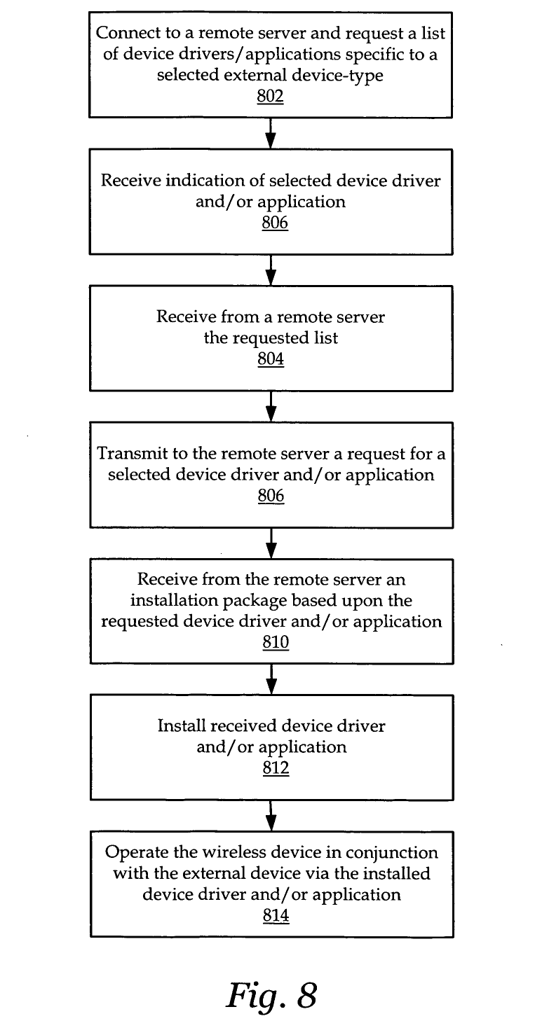

Further, in this optional aspect, the method may further include receiving the survey results of the device driver and/or application status information on the external device (Step 710), and determining if updates are available and/or desired (Step 712). For example, external device manager 120 may receive and store survey results 333, such as a list of the above-described device driver and/or application status information. Further, external device manager 120 may provide the survey results 33 to the user of the wireless device 102 and/or external device 106 via a user interface on either device. Additionally, depending on a user input and/or based on an update setting, if an update is available and/or desired, then the method performs the updating, as discussed below with regard to FIG. 8 (see Step 802), and then the method returns to Step 714, discussed below. If no update is available and/or desired, then this optional aspect terminates and returns to Step 714, discussed below.

Upon establishing communications with the external device, and optionally upon updating device drivers and/or applications on the external device, the method continues with determining whether the wireless device user would like to use an external device resource (Step 714) and/or download an application onto the external device (Step 716).

If utilization of an external device resource is desired, then the wireless device receives an indication of one or more selected resources to utilize (Step 718). For example, in some aspects, the external device manager 120 receives the selection from the user of the wireless device 102 via a user interface. In other aspects, the external device manager 120 and/or wireless application 114 may automatically select the one or more external device resources 132 based on predetermined settings and/or based on the specific functionality of the wireless application 114. For example, if the wireless application 114 is known to utilize a predetermined amount of data storage in excess of the available memory/storage on the wireless device 102, then the external device manager control logic 328 may automatically select an external device memory and/or data resource to utilize.

Upon identification of one or more external device resources to utilize, the wireless device verifies that the proper device driver is resident to allow the wireless application to communicate with the selected external device resource (Step 720). For example, external device manager 120 may be operable to compare the existing device drivers, such as listed in survey results 333 or as independently verified, with the selected external device resource to ensure that a proper device driver is resident on external device 106.

If the proper driver is not resident, then the method returns installs the proper driver (Step 706), as described above.

If the proper driver is resident, then the wireless device utilizes the one or more selected external device resources (Step 722). For example, wireless application 114 is operable during its execution to communicate with the selected external device resource, such as a memory, data storage, processor, communications interface, etc.

After the external device resource has been utilized, as desired, by the wireless application, the method may further include determining if the respective one or more device drivers should be uninstalled (Step 724). For example, upon the conclusion of the execution of wireless application 114, the external device manager 120 may query the wireless device user whether or not to uninstall the respective device driver(s). Alternatively, the determination may be based on predetermined settings associated with a give wireless application 114 and/or associated with external device manager 120.

In any case, if the device drivers are not to be uninstalled, then the method terminates (Step 728).

If the device drivers are to be uninstalled, then the method proceeds and performs a de-installation of the respective one or more device drivers utilized by the wireless application (Step 726), followed by the termination of the method (Step 728). For example, the external device manager 120 may execute device driver/device driver/application module management package 122, which is operable to de-install the respective device drivers. After the de-install process is complete, then the method terminates.

Optionally, after the utilization of the external device resources (Step 722), the method may provide the option for the wireless device to download another device driver and/or an application module to the external device (Step 716), which will be discussed below in more detail.

As noted above, after a determination not to utilize an external device resource (Step 714), or optionally after utilizing an external device resource (Step 722), the method may provide the option for the wireless device to download another device driver and/or an application module to the external device (Step 716). For example, external device manager 120 may execute device driver/device driver/application module management package 122, which is operable to download an application from the wireless device to the external device.

If the wireless device receives an input that a download is not desired, then the method continues to Step 724, as discussed above. For example, external device manager 120 may receive a response to a user-directed query whether or not to download a device driver and/or an application. Alternatively, the indication may be based on predetermined settings associated with a give wireless application 114 and/or associated with external device manager 120.

If the wireless device receives an input that a download is desired, then the method continues to Step 802 (FIG. 8), as discussed below. For example, external device manager 120 may receive a response to a user-directed query whether or not to download a device driver and/or an application. Alternatively, the indication may be based on predetermined settings associated with a give wireless application 114 and/or associated with external device manager 120.

Referring to FIG. 8, the method may include identifying and downloading device drivers and/or applications to the external device, either based on an indication for obtaining updates resulting from a survey (FIG. 7, Step 712), an indication to obtain a device driver and/or application as opposed to utilizing a device resource (FIG. 7, Steps 714 and 716) and/or based on a similar indication received after utilizing the device resource (FIG. 7, Steps 722 and 716).

At this point, the method may include connecting with a remote server and requesting a list of device drivers and/or applications specific to an identified external device-type (Step 802). For example, external device manager 120 may be operable to receive identifying information associated with the external device type, such as external device type parameter 326. This identifying information may be selected from a list of potential external device types, and/or entered by a device user and associated with a device type parameter 326 at the wireless device 102 and/or at the remote server 106. Further, the external device manager 120 may comprise one or more configuration parameters 322 that identify a given remote server 104 to query for this information.

Further, for example, in some aspects, remote server 104 may comprise device driver/application module install packages 122 designed to be loaded onto specific external device-types that a user may first identify. Accordingly, a user of the wireless device 102 may select, via operation of user interface 302, a specific external device type according to the connected external device 106 from a menu presented by an external device type module 324. The wireless device 102 may store the selected external device type as external device type parameter 326. In some embodiments, external device type module 324 is downloaded as part of external device manager 120. In other aspects, the external device type module 324 is configurable and may be downloaded from the remote server 104.

Additionally, in these aspects, upon selecting the external device type, external device manager 120 is operable to connect to remote server 104 and transmit the external device type parameter 326 in order to receive a menu from module 308 of on-demand applications specific to the external device 106. The connection protocol may be HTTP, FTP or any other protocol available to enable the transmission of data over the network 110.

The method may further include receiving from the remote server a list of available, device-type specific device drivers and/or applications (Step 804). For example, the wireless device 102 is operable to receive from remote server 104 a menu from module 308 having on-demand device driver list 311 and/or on-demand application list 309 specific to the specified external device 106. External device manager 120 may further be operable to display the menu from module 308 using output mechanism 204.

The method may further include receiving an indication to install a selected one or more of an available device driver and/or an available application (Step 806). For example, the wireless device 102 may receive user selections, via the operation of user interface 302, of an on-demand device driver and/or application from a menu from module 308. Further, the wireless device 102 may store the selected device driver and/or application as selected device driver/application parameter 316.

Further, the method may include transmitting to the remote server a request for a selected device driver and/or application (Step 808). For example, external device manager 120 may be operable to initiate the transmission of parameter 316 to the remote server 104.

The method may further include receiving from the remote server an installation package based on the requested device driver and/or application (Step 810). For example, the wireless device 102 may receive and store a device driver/application management package 122 downloaded from the remote server 104 based upon the requested device driver and/or application for the external device 106.

Additionally, the method may include the wireless device installing the received device driver and/or application onto the external device (Step 812). For example, the external device manager 120 may execute the received device driver/application management package 122, which is operable to install the requested driver/application onto the external device 106.

Further, the method may include performing operations on the wireless device in conjunction with the external device via the downloaded device driver and/or application (Step 814). For example, in some aspects, the external device 106 may execute an application module 136 to manage, control, and/or monitor operations on the wireless device 102.

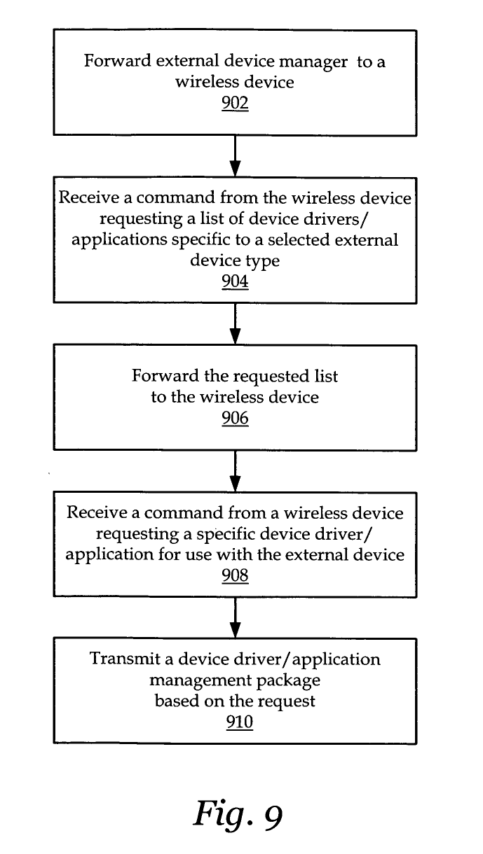

Referring to FIG. 9, in some aspects, a method operable on remote server 104 is illustrated for communicating with the wireless device 102 in correspondence with the method in the flowchart of FIGS. 7 and 8. Specifically, the method of FIG. 9 is operable to load device driver/device driver/application module management package 122 on a wireless device 102, after which the wireless device 102 is operable to automatically install one or more of an interface driver 136 and/or an application module 136 on a connected external device 106.

At step 902, a user manager module 118 resident in memory 402 of the remote server 104 may, upon receiving a connection request from a wireless device 102, authenticate the identity of the wireless device 102 using authorization logic 412. Upon authentication, the user manager control logic 404 may forward the external device manager 120 to the wireless device 102 over network 110 using any available protocol including, for example, HTTP and FTP. In some embodiments, user manager module 118 is operable to receive acknowledgment of the transmission of the external device manager 120.

At step 904, the remote server 104 may receive a request to transmit a menu from module 308 listing applicable device drivers and/or applications specific to the external device 106 connected to the wireless device 102. In one embodiment, remote server 104 may receive a command 320 comprising and external device type parameter 326 specifying the type of external device 106 connected to the wireless device 102.

In response to the request received at step 904, remote server 104 is operable, at step 906, to forward the menu from module 308 to the wireless device 102. Module 308 may list device drivers and/or applications applicable to the specific external device 106 connected to the wireless device 102.

At step 908, remote server 104 is operable to receive a request for the download of a specific device driver/application module management package 122. In one embodiment, a command 320, comprising a selected device driver/application parameter 316, may be received and parsed by the user manager control logic 404.

At step 910, remote server 104 is operable to transmit the respective management package 122 to the wireless device 102 based upon the selected device driver/application parameter 316.

Thus, the described aspects allow wireless device-centric or handset-centric control of an external device resource and/or on-demand installation and de-installation of drivers and/or applications on an external device 106 connected to a wireless device 102.

Thus, in one example case that is not to be construed as limiting, a method of using device resources on an external device connected to a wireless device comprises receiving on the wireless device a wireless device application. The method further includes executing the wireless device application whereby the application records device function-related data in a memory on the wireless device. Further, the method includes automatically determining that additional memory resources are required by the wireless device application. As such, the method includes connecting an external device comprising available memory to the wireless device. Further, the method includes automatically installing wireless device interface components on the external device, and recording at least a portion of the function-related data in the available memory of the external device. Additionally, in some aspects, the method may further comprise the wireless device automatically detecting, on the external device, a network connection to a remote server, and transmitting at least a portion of the stored function-related data to the remote server over the network connection detected on the external device.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the foregoing disclosure shows illustrative aspects and/or aspects, it should be noted that various changes and modifications could be made herein without departing from the scope of the described aspects and/or aspects as defined by the appended claims. Furthermore, although elements of the described aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method of a wireless device utilizing a resource on a connected external device, comprising:
executing on a wireless device an application operable to utilize a predetermined device resource, wherein the wireless device comprise a first one of the predetermined device resource;
connecting an external device to the wireless device, the external device comprising a second one of the predetermined device resource; and
automatically switching the wireless device application between utilizing the first one of the predetermined resource and the second one of the predetermined resource.

2. The method of claim 1, wherein automatically switching is based on predetermined external device resource selection logic.

3. The method of claim 1, further comprising installing an interface mechanism on the connected external device, the interface mechanism operable to enable communication between the wireless device application and the predetermined device resource on the external device.

4. The method of claim 3, further comprising obtaining on the wireless device the interface mechanism from a remote server across a wireless network.

5. The method of claim 1, further comprising installing an external device application module in a memory of the external device, the application module executable on the external device in conjunction with the wireless device application.

6. The method of claim 5, wherein installing the external device application module further comprises:
obtaining on the wireless device an application management package; and
installing the external device application on the external device using the application management package.

7. The method of claim 6, further comprising obtaining the application management package from a remote server across a wireless network.

8. The method of claim 6, further comprising receiving a selection of the external device application module from a plurality of application modules.

9. The method of claim 8, wherein the selection is based upon an external device type.

10. The method of claim 6, further comprising obtaining on the wireless device an application module management package from a remote server across a wireless network.

11. The method of claim 5, further comprising uninstalling the external device application module under the control of the wireless device.

12. The method of claim 1, wherein automatically switching communication further comprises transmitting data to the external device, wherein the external device is operable to store the data within a memory of the external device.

13. The method of claim 1, wherein automatically switching communication further comprises transmitting data to a communication interface on the external device operable to forward the data to a remote server.

14. The method of claim 1, wherein automatically switching communication further comprises receiving processed data from the external device.

15. The method of claim 1, further comprising communicating with a remote server using a network connection selected from a plurality of network connections, the plurality of network connections comprising at least one external device resident network connection.

16. The method of claim 1, further comprising modifying at least one of a device driver and an external device application previously installed on the external device.

17. A machine-readable medium comprising instructions which, when executed by a machine, cause the machine to perform operations comprising:
executing on a wireless device an application operable to utilize a predetermined device resource, wherein the wireless device comprise a first one of the predetermined device resource;
connecting an external device to the wireless device, the external device comprising a second one of the predetermined device resource; and
automatically switching the wireless device application between utilizing the first one of the predetermined resource and the second one of the predetermined resource.

18. At least one processor configured to perform the actions of:
executing on a wireless device an application operable to utilize a predetermined device resource, wherein the wireless device comprise a first one of the predetermined device resource;
connecting an external device to the wireless device, the external device comprising a second one of the predetermined device resource; and
automatically switching the wireless device application between utilizing the first one of the predetermined resource and the second one of the predetermined resource.

19. A wireless device, comprising:
means for executing on a wireless device an application operable to utilize a predetermined device resource, wherein the wireless device comprise a first one of the predetermined device resource;
means for connecting an external device to the wireless device, the external device comprising a second one of the predetermined device resource; and
means for automatically switching the wireless device application between utilizing the first one of the predetermined resource and the second one of the predetermined resource.

20. A wireless device, comprising:
a processing engine;
a memory accessible by the processing engine;
a communication module operable to exchange communications between the processor and the memory, and between the wireless device and an external device having a first predetermined device resource;
a second predetermined device resource in communication with the communication module;
a first application resident in the memory and executable by the processing engine, the first application operable to utilize either of the first predetermined device resource and the second predetermined device resource; and
a selection module resident in the memory and executable by the processing engine, the selection module operable to automatically switch the first application between utilizing the second predetermined device resource and with the first predetermined device resource during execution of the first application.

21. The device of claim 20, wherein the selection module further comprises a predetermined external device resource selection logic operable to determine when to automatically switch the utilization between the first predetermined device resource and the second predetermined device resource.

22. The device of claim 20, wherein the first application is further operable to utilize the first predetermined resource for at least one of storing data, processing data and transmitting data.

23. The device of claim 20, wherein the wireless device is configured to transmit data to the remote server via the external device during utilization of the first device resource.

24. The device of claim 20, wherein the wireless device further comprises an external device manager having an interface mechanism, the external device manager operable to install an interface mechanism on the external device, the interface mechanism operable to enable communication between the first application and the first predetermined device resource on the external device.

25. The device of claim 20, wherein the wireless device further comprises an external device manager having an on-demand module comprising at least one of a device driver and an external device application, wherein the on-demand module is operable to download and install on the external device at least one of the device driver and the external device application.

26. The device of claim 25, wherein the device driver and the external device application comprise respective updated versions of an existing device driver and an existing external device application resident on the external device.

27. The device of claim 25, wherein the device driver and the external device application are respectively selected from a plurality of device drivers and a plurality of external device applications based on a device type associated with the external device.

28. The device of claim 27, further comprising an external device-type selection module having a list of a plurality of potential external devices, wherein the device type corresponds to a selected one of the plurality of potential external devices.

29. The device of claim 20, further comprising an external device survey module operable to inspect the external device and generate a survey result comprising a list of at least one of a device driver and an external device application resident on the external device, where in the survey result further comprises version information associated with the respective one of the device driver and the external device application.

30. The device of claim 20, further comprising a limited service configuration operable to establish on the wireless device a limited service communication channel across a wireless network.

31. A method of installing an application on an external device connected to a wireless device on a wireless network, comprising:
receiving a command from the wireless device connected to the external device, the command comprising a request for an application management package executable on the wireless device, wherein the application management package is operable to install an external device application on the external device, wherein the external device application is operable exchange data and execute in conjunction with a wireless device application executing on the wireless device; and
transmitting the application management package to the wireless device.

32. The method of claim 31, further comprising receiving from the wireless device a request for a listing of external device applications executable on a selected external device type based on a selected one of a plurality of external device types.

33. The method of claim 31, further comprising receiving data from the external device via an external device resource operating under the control of the wireless device.

34. At least one processor configured to perform the actions of:
receiving a command from a wireless device connected to an external device, the command comprising a request for an application management package executable on the wireless device, wherein the application management package is operable to install an external device application on the external device, wherein the external device application is operable exchange data and execute in conjunction with a wireless device application executing on the wireless device; and
transmitting the application management package to the wireless device.

35. A machine-readable medium comprising instructions which, when executed by a machine, cause the machine to perform operations comprising:
receiving a command from a wireless device connected to an external device, the command comprising a request for an application management package executable on the wireless device, wherein the application management package is operable to install an external device application on the external device, wherein the external device application is operable exchange data and execute in conjunction with a wireless device application executing on the wireless device; and
transmitting the application management package to the wireless device.

36. An apparatus, comprising:
means for receiving a command from a wireless device connected to an external device, the command comprising a request for an application management package executable on the wireless device, wherein the application management package is operable to install an external device application on the external device, wherein the external device application is operable exchange data and execute in conjunction with a wireless device application executing on the wireless device; and
means for transmitting the application management package to the wireless device.

37. An apparatus for transmitting an external device application to a wireless device, comprising:
a processor;
a memory in communication with the processor, the memory comprising an application management package executable on the wireless device, wherein the application management package is operable to install an external device application on the external device, wherein the external device application is operable exchange data and execute in conjunction with a wireless device application executing on the wireless device; and
a user manager control logic resident in the memory and executable by the processor, the user manager control logic configured to transmit the application management package to the wireless device across a wireless network.

38. The apparatus of claim 37, further comprising an on-demand device driver/application module resident in the memory and having a listing of at least one of a plurality of external device applications and a plurality of device drivers, wherein the the external device application associated with the application management module comprises a selected one of the plurality of external device applications based on a device type.

39. The apparatus of claim 37, further comprising an information repository operable to receive data transmitted from the external device via an external device resource operating under the control of the wireless device.

40. A method of using device resources on an external device connected to a wireless device, comprising:
receiving on a wireless device a wireless device application;
executing the wireless device application whereby the application stores wireless device function-related data in a memory on the wireless device;
automatically determining that additional memory resources are required by the application;
connecting an external device comprising available memory to the wireless device;
automatically installing wireless device interface components on the external device; and
storing at least a portion of the function-related data generated by the wireless device application in the available memory of the external device.

41. The method of claim 40, further comprising the wireless device automatically detecting, on the external device, a network connection to a remote server, and transmitting at least a portion of the stored function-related data to the remote server over the network connection detected on the external device.
